(19) United States
(12) Patent Application Publication
(10) Pub. No.: US 2019/0114010 A1
(43) Pub. Date: Apr. 18, 2019

(54) DISPLAY DEVICE

(71) Applicant: Chunghwa Picture Tubes, LTD., Taoyuan City (TW)

(72) Inventors: Kai-Wen Chiu, Taoyuan City (TW); Fang-Yi Chou, New Taipei City (TW)

(73) Assignee: Chunghwa Picture Tubes, LTD., Taoyuan City (TW)

(21) Appl. No.: 15/844,611

(22) Filed: Dec. 17, 2017

(30) Foreign Application Priority Data
Oct. 16, 2017 (CN) 201710957249.5

(51) Int. Cl. G06F 3/041; G06F 3/044

(52) U.S. Cl. CPC G06F 3/0412; G06F 2203/04107; G06F 3/044

(57) ABSTRACT

A display device including a display module and a cover plate is provided. The cover plate is disposed on the display module, the cover plate has a central region and a peripheral region, and the peripheral region is located at one or more side of the central region. The cover plate also has a main body and a protrusion. The main body continuously extends from the central region to the peripheral region. The protrusion is located in the central region and between the main body and the display module, and a bottom surface of the cover plate at the central region is located closer to a top surface of the display module in a height direction than a bottom surface of the cover plate at the peripheral region because of the protrusion.

### CROSS-REFERENCE TO RELATED APPLICATION

This application claims the priority benefit of China application serial no. 201710957249.5, filed on Oct. 16, 2017. The entirety of the above-mentioned patent application is hereby incorporated by reference herein and made a part of this specification.

### BACKGROUND

### Field of the Disclosure

The invention relates to a display device, and specifically relates to a display device having a cover plate.

### Description of Related Art

Nowadays, a layer as a protective cover plate is adhered to the top of the display module in the display device, so as to protect the display module. The technology of adhering the cover plate is mainly categorized into air bonding and direct bonding. The air bonding technology is based on adhering the protective cover plate on the outer housing by an adhesive layer having a shape of a ring, this approach has the advantages of simple production process and low cost, but there is an air gap between the protective cover plate and the display module. Therefore, the light is refracted when passing between different mediums, thus causing overlapping image phenomenon so as to seriously affect image quality. The direct bonding technology is based on filling a space between the protective cover plate and the display module with an optical clear adhesive (OCA) or an optical clear resin so that the two components adhere to each other. Adopting optical clear adhesive can avoid the poor image quality problem caused by mismatched refractive indexes in air bonding. However, the direct bonding technology requires more complicated manufacturing method, more machines, and higher cost than the air bonding technology. Therefore, it is urgent to find a technology of adhering the cover plate that has advantages of both air bonding and direct bonding technologies.

### SUMMARY

The invention is directed to a display device in which both advantages that simple production process in air bonding and having image quality as good as using direct bonding can be achieved in assembling a cover plate and a display module.

In one embodiment of the invention, a display device includes a display module and a cover plate. The cover plate is disposed on the display module, the cover plate has a central region and a peripheral region located on at least one side of the central region, and the cover plate includes a main body and a protrusion. The main body continuously extends from the central region to the peripheral region. The protrusion is located in the central region and between the main body and the display module. A bottom surface of the cover plate at the central region is located closer to a top surface of the display module in a height direction than a bottom surface of the cover plate at the peripheral region.

In one embodiment of the invention, the display device further includes an adhesive layer and a frame. The frame surrounds the display module and includes a bearing portion. The peripheral region of the cover plate is adhered to the bearing portion of the frame by the adhesive layer.

In one embodiment of the invention, the protrusion is in contact with the display module.

In one embodiment of the invention, the thickness of the protrusion is equal to the sum of the thickness of the adhesive layer and the thickness of the bearing portion of the frame.

In one embodiment of the invention, display device further includes an adhesive layer, wherein the adhesive layer is disposed between the protrusion of the cover plate and the display module so that the protrusion of the cover plate is adhered to the display module.

In one embodiment of the invention, a top surface of the cover plate away from the display module is a non-planar surface or a planar surface.

In one embodiment of the invention, a part of a top surface of the cover plate at the central region is located farther from the top surface of the display module in a height direction than a part of the top surface of the cover plate at the peripheral region.

In one embodiment of the invention, the main body and the protrusion of the cover plate are integrally formed.

In one embodiment of the invention, the bottom surface of the cover plate at the peripheral region is a planar surface.

In one embodiment of the invention, the bottom surface of the cover plate at the peripheral region is a non-planar surface.

In the display device of the embodiments of the invention, the bottom surface of the cover plate at the central region is located closer to the top surface of the display module in the height direction than the bottom surface of the cover plate at the peripheral region because of the protrusion. Thus, the gap between the cover plate and the display module at the central region is reduced and even eliminated, so as to avoid overlapping image phenomenon on the screen caused by the gap between the cover plate and the display module. Otherwise, a low cost process may be adopted to adhere the display module and the cover plate with each other in the embodiments of the invention.

In order to make the aforementioned and other features and advantages of the invention more comprehensible, embodiments accompanying figures are described in detail belows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional schematic view illustrating a display device in an embodiment of the invention.

FIG. 2 is a schematic view illustrating an exemplary implementation of a display module of a display device in another embodiment of the invention.

FIG. 3A is a cross-sectional schematic view illustrating a display device in another embodiment of the invention.

FIG. 3B is a cross-sectional schematic view illustrating a display device in yet another embodiment of the invention.

FIG. 4 is a cross-sectional schematic view illustrating a display device in yet an embodiment of the invention.

### DESCRIPTION OF THE EMBODIMENTS

Descriptions of the invention are given with reference to the exemplary embodiments illustrated with accompanied drawings. Wherever possible, in the drawings and the specification, the same or similar parts are denoted with same reference numerals.

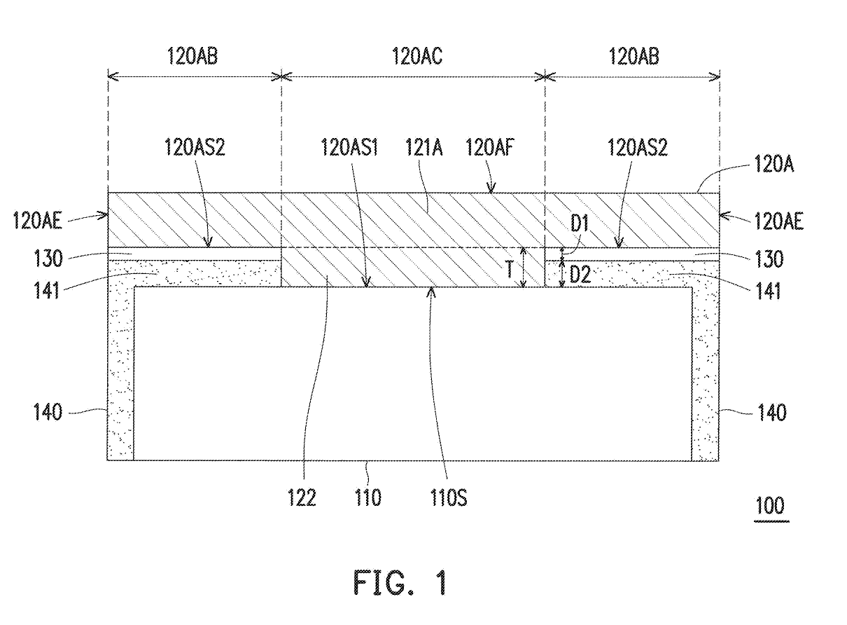

FIG. 1 is a cross-sectional schematic view illustrating a display device in an embodiment of the invention. Referring to FIG. 1, a display device 100 includes a display module 110, a cover plate 120A, an adhesive layer 130, and a frame 140. The cover plate 120A is disposed on the display module 110, the frame 140 surrounds the display module 110, and the cover plate 120A is attached/adhered to the frame 140 by the adhesive layer 130.

The cover plate 120A has a central region 120AC and a peripheral region 120AB. The peripheral region 120AB is located on at least one side of the central region 120AC. From the view in FIG. 1, the peripheral region 120AB is located at the periphery of the central region 120AC and surrounds the central region 120AC. In the present embodiment, the cover plate 120A may be a glass substrate, a sapphire substrate, or a plastic substrate. The material of the plastic substrate may include Polyethylene terephthalate, polycarbonate, polymethyl methacrylate, or other suitable plastic materials for cover plate, but the invention is not limited thereto. The display device 100 provides not only display function by using the display module 110 but also touch function. In some embodiments, different processes may be used to dispose a touch structure on the cover plate 120A, such as One Glass Solution (OGS), One Plastic Solution (OPS), Glass-Glass (GG), Glass-Film-Film (GFF), or other suitable processes for disposing a touch component on the cover plate 120A. In other embodiments, the component or structure having touch function may also be disposed in or built-in the display module 110.

The cover plate 120A includes a main body 121A and a protrusion 122, and the main body 121A and the protrusion 122 are two adjacent parts in the thickness direction and are integrally formed, but the invention is not limited thereto. In other embodiments, the main body 121A and the protrusion 122 may be formed by combining two independent structures. The main body 121A continuously extends from the central region 120AC to the peripheral region 120AB. The protrusion 122 is located in the central region 120AC and between the main body 121A and the display module 110.

The area and location of the central region 120AC of the cover plate 120A depend on the size and the position of the protrusion 122. That is, the protrusion 122 determines the area of the central region 120AC of the cover plate 120A. In the present embodiment, the central region 120AC may be considered as the area where the protrusion 122 is located.

Because of disposing the protrusion 122, a bottom surface 120AS1 of the cover plate 120A at the central region 120AC is located closer to a top surface 110S of the display module 110 in a height direction than a bottom surface 120AS2 of the cover plate 120A at the peripheral region 120AB, and thus the protrusion 122 is closer to the display module 110 than the main body 121A. In the present embodiment, a top surface 120AF away from the display module 110 of the cover plate 120A, the bottom surfaces 120AS1 and 120AS2 at the central region 120AC and the peripheral region 120AB, and a side surface 120AE of the cover plate 120A are all planar surfaces, but the invention is not limited thereto. Otherwise, the protrusion 122 may be considered as a part protruding from the bottom surface 120AS2 of the cover plate 120A at the peripheral region 120AB toward the display module 110 in a height direction. Therefore, the cover plate 120A at the central region 120AC has a greater thickness than the peripheral region 120AB, and the cover plate 120A has a constant thickness at the peripheral region 120AB, but the invention is not limited thereto.

In the present embodiment, the material of the adhesive layer 130 may be a double sided tape, VHB™ foam tape, acrylic foaming glue, AB glue, or optical clear adhesive (OCA), optical clear resin (OCR), etc. The frame 140 surrounds the display module 110 and the display module 110 is confined in the frame 140. The frame 140 includes a bearing part 141 which is laterally extended from the end portion of the sidewall of the frame 140 to cover the periphery portion of the display module 110. To be more specific, the bearing part 141 is located at the peripheral region 120AB and between the cover plate 120A and the display module 110. The cover plate 120A is adhered to the bearing portion 141 of the frame 140 at the peripheral region 120AB by the adhesive layer 130. In order to protect the display module 110, the bearing part 141 may substantially have a ring shape when viewing from the top view, and the adhesive layer 130 is disposed to distribute along with the bearing part 141. Therefore, the cover plate 120A in the present embodiment is adhered by using air bonding technology.

Not only does the frame 140 protect and surround the display module 110, the frame 140 also serves as one of assembly members between the cover plate 120A and the display module 110. For example, in the display device 100, the bearing part 141 is used to support the cover plate 120A, and the cover plate 120A is adhered to the bearing part 141 of the frame 140 by the adhesive layer 130 having adhesive properties, so that the display device 100 is completely assembled. Otherwise, the thickness T of the protrusion 122 may be defined as the height of the protrusion 122 protruding from the bottom surface 120AS2 of the cover plate 120A at the peripheral region 120AB to the display module 110. In the present embodiment, the thickness T of the protrusion 122 is equal to the sum of the thickness D1 of the adhesive layer 130 and the thickness D2 of the bearing portion 141 of the frame 140. Therefore, the protrusion 122 is in contact with the display module 110. In other words, there may not be a gap between the protrusion 122 and the display module 110. When the external light passes from the cover plate 120A through the protrusion 122 to enter the display module 110, the secondary refraction of the light caused by mismatched refractive indexes, which is generated by a gap between the cover plate 120A and the display module 110, does not happen and thus the overlapping image phenomenon is neither generated on the screen. In addition, the disposition of the protrusion 122 assists in avoiding the situation that the image quality of the display device 100 deteriorates due to the assembly of the cover plate 120A. As a result, the cover plate 120A may be assembled to the display module 110 by simply adopting air bonding technology, and the display device 100 may still provide good display effect.

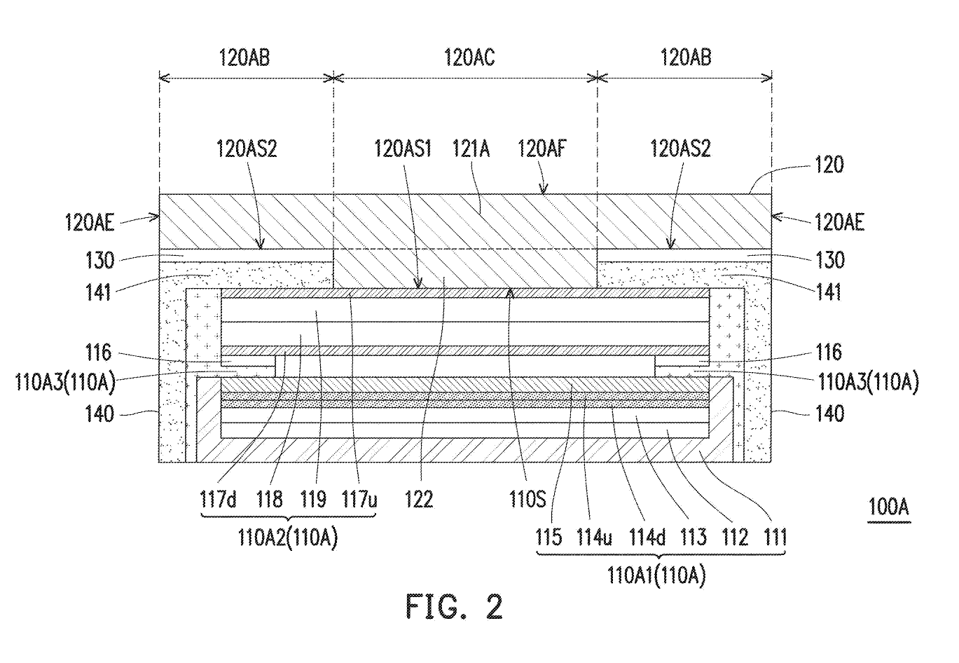

FIG. 2 is a schematic view illustrating an exemplary implementation of a display module of a display device in another embodiment of the invention. Referring to FIG. 2, a display device 100A of the present embodiment includes a display module 110A, a cover plate 120A, an adhesive layer 130, and a frame 140. The cover plate 120A is disposed on the display module 110A and has a central region 120AC and a peripheral region 120AB. The peripheral region 120AB is located at the periphery of the central region 120AC and surrounds the central region 120AC. The cover plate 120A includes a main body 121A and a protrusion 122, the main body 121A continuously extends from the central region 120AC to the peripheral region 120AB. The protrusion 122 is located in the central region 120AC and between the main body 121A and the display module 110A. Because of, disposing the protrusion 122, a bottom surface 120AS1 of the cover plate 120A at the central region 120AC is located closer to a top surface 1105 of the display module 110A in a height direction than a bottom surface 120AS2 of the cover plate 120A at the peripheral region 120AB, and thus the protrusion 122 is closer to the display module 110A than the main body 121A. In the present embodiment, a top surface 120AF of the cover plate 120A away from the display module 110A and the bottom surfaces 120AS1 and 120AS2 thereof at the central region 120AC and the peripheral region 120AB are all planar surfaces, but the invention is not limited thereto. The frame 140 surrounds the display module 110A and includes a bearing portion 141. The peripheral region 120AB of the cover plate 120A is adhered to the bearing portion 141 of the frame 140 by the adhesive layer 130.

In the display device 100A of the present embodiment, the display module 110A includes a backlight module 110A1 and a display panel 110A2, and the display panel 110A2 is located on the backlight module 110A1. In view of the entire display device 100A, the display panel 110A2 is located between the backlight module 110A1 and the cover plate 120A. The backlight module 110A1 is composed of a light source (not shown), a bottom frame 111, a light-guiding plate 112, a diffusion plate 113, a lower prism plate 114d, an upper prism plate 114u, and a brightness enhancement film 115, and the bottom frame 111 supports the light source, the light-guiding plate 112, the diffusion plate 113, the lower prism plate 114d, the upper prism plate 114u, and the brightness enhancement film 115. The light source may be a side-type light source located at a side of the light-guiding plate 112 or may be a direct-type light source located between the light-guiding plate 112 and the bottom frame 111. The light-guiding plate 112, the diffusion plate 113, the lower prism plate 114d, the upper prism plate 114u, and the brightness enhancement film 115 are optical films to assist in transforming the light from the light source to the light field irradiating on a whole surface of the display panel 110A2. In other words, the backlight module 110A1 is used to provide a surface light source having uniform and consistent brightness for the display device 100A. However, the combination of the optical films is not limited in the invention. In some embodiments, the way of disposing the optical films in the backlight module 110A1 may be more complicated, otherwise more simplified. The display panel 110A2 is composed of a lower polarizing plate 117d, an active component array substrate 118, a display medium (not shown), a color filter substrate 119, and an upper polarizing plate 117u. The display medium is disposed between the active component array substrate 118 and the color filter substrate 119, the lower polarizing plate 117d is disposed on the active component array substrate 118, the upper polarizing plate 117u is disposed on the color filter substrate 119, and the active component array substrate 118, the display medium, and the color filter substrate 119 are located between the lower polarizing plate 117d and the upper polarizing plate 117u. The material of the display medium may be liquid crystal, electrophoresis micro-particles, or other medium materials used for light-guiding, but the invention is not limited thereto. The display module 110A may also include a central frame 110A3, a portion of the central frame 110A3 is clamped between the display panel 110A2 and the backlight module 110A1, and the display panel 110A2 is adhered to the portion of the central frame 110A3 by the adhesive layer 116 so that each and every components of the display module 110 is assembled and fixed together.

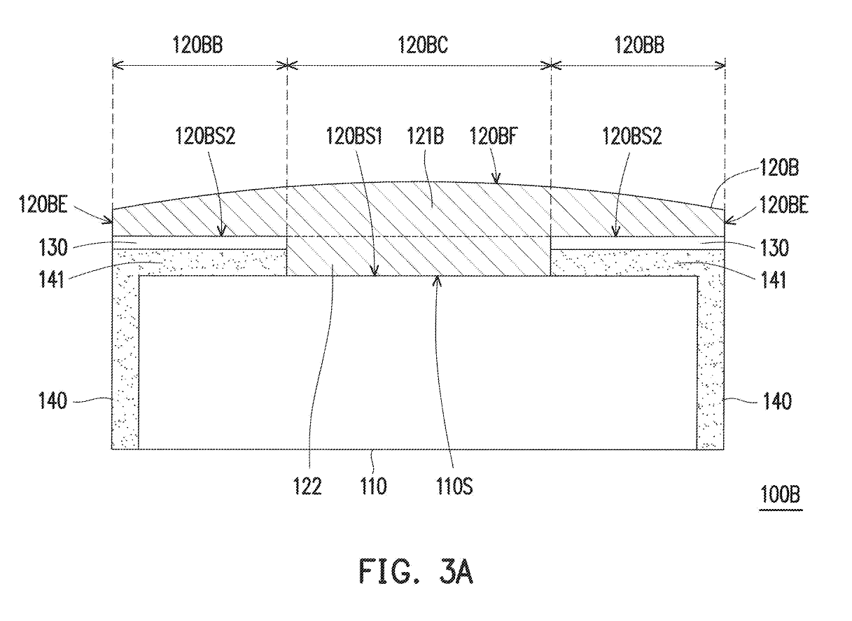

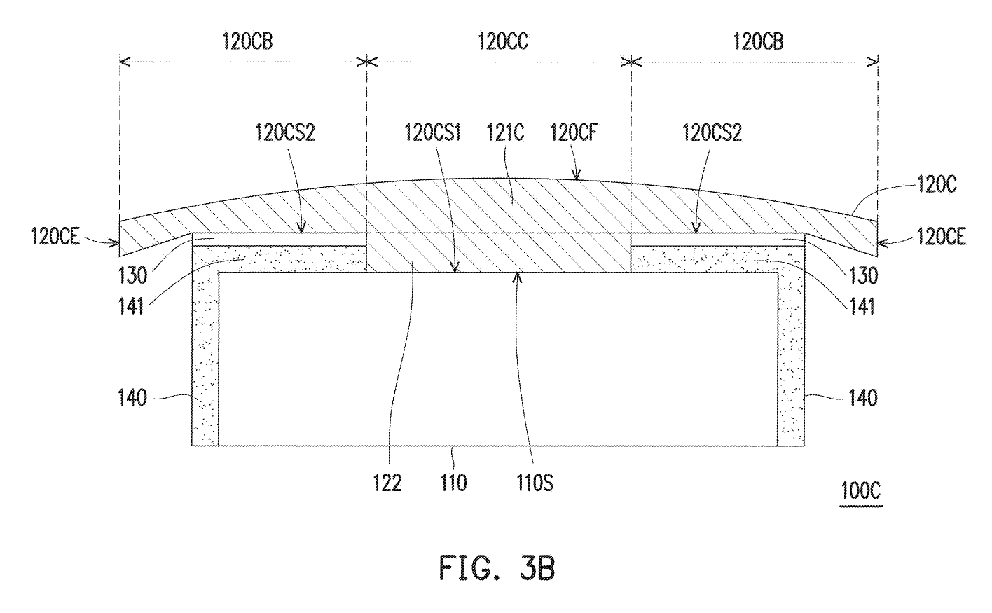

FIG. 3A is a cross-sectional schematic view illustrating a display device in another embodiment of the invention, and FIG. 3B is a cross-sectional schematic view illustrating a display device in yet another embodiment of the invention. Referring to FIG. 3A, a display device 100B of the present embodiment includes a display module 110 and a cover plate 120B, the cover plate 120B is disposed on the display module 110 and has a central region 120BC and a peripheral region 120BB, and the peripheral region 120BB is located at one or more side of the central region 120BC. In the FIG. 3A, the peripheral region 120BB is located at the periphery of the central region 120BC and surrounds the central region 120BC, and the cover plate 120B includes a main body 121B and the protrusion 122. The main body 121B continuously extends from the central region 120BC to the peripheral region 120BB. The protrusion 122 is located in the central region 120BC and between the main body 121B and the display module 110. Because of disposing the protrusion 122, a bottom surface 120BS1 of the cover plate 120B at the central region 120BC is located closer to a top surface 110S of the display module 110 in a height direction than a bottom surface 120BS2 of the cover plate 120B at the peripheral region 120BB, and thus the protrusion 122 is closer to the display module 110 than the main body 121B. The display device 100B further includes an adhesive layer 130 and a frame 140. The frame 140 surrounds the display module 110 and includes a bearing portion 141. The cover plate 120B is adhered to the bearing portion 141 of the frame 140 at the peripheral region 120BB by the adhesive layer 130. Otherwise, in the present embodiment, an upper surface 120BF of the cover plate 120B away from the display module 110 is a non-planar surface, and a part of a top surface 120BF of the cover plate 120B at the central region 120BC is located farther from the top surface 110S of the display module 110 in a height direction than a part of the top surface 120BF of the cover plate 120B at the peripheral region 120BB. For example, the upper surface 120BF of the cover plate 120B may be a curved surface which has the periphery curved toward a side closer to the display module 110. A side surface 120BE of the cover plate 120B is a planar surface aligned with the edge of the frame 140. In other embodiments, the structure of the cover plate 120B may be served as the 2.5D glass structure that is commercially available. Thus, the upper surface 120BF of the cover plate 120B is a planar surface, and the side surface 120BE of the cover plate 120B is a curved surface. However, the invention is not limited thereto. In other possible embodiments, the upper surface 120BF of the cover plate 120B is a planar surface at the central region 120BC and is a curved surface at the peripheral region 120BB.

Referring to FIG. 3B, a display device 100C of the present embodiment includes a display module 110 and a cover plate 120C, the cover plate 120C is disposed on the display module 110 and has a central region 120CC and a peripheral region 120CB. The peripheral region 120CB is located on at least one side of the central region 120CC. From the view in FIG. 3B, the peripheral region 120CB is located at the periphery of the central region 120CC and surrounds the central region 120CC. The cover plate 120C further includes a main body 121C and a protrusion 122. The main body 121C continuously extends from the central region 120CC to the peripheral region 120CB. The protrusion 122 is located in the central region 120CC and between the main body 121C and the display module 110. Because of disposing the protrusion 122, a bottom surface 120CS1 of the cover plate 120C at the central region 120CC is located closer to a top surface 110S of the display module 110 in a height direction than a bottom surface 120CS2 of the cover plate 120C at the peripheral region 120CB, and thus the protrusion 122 is closer to the display module 110 than the main body 121C. The display device 100C further includes an adhesive layer 130 and a frame 140. The frame 140 surrounds the display module 110 and includes a bearing portion 141. The cover plate 120C is adhered to the bearing portion 141 of the frame 140 at the peripheral region 120CB by the adhesive layer 130. Otherwise, in the present embodiment, an upper surface 120CF of the cover plate 120C away from the display module 110 is a non-planar surface, and a part of a top surface 120CFof the cover plate 120C at the central region 120CC is located farther from the top surface 110S of the display module 110 in a height direction than a part of the top surface 120CF of the cover plate 120B at the peripheral region 120CB, the bottom surface 120CS2 of the cover plate 120C is a nonplanar surface at the peripheral region 120CB and the side surface 120CE of the cover plate 120C is a planar surface. For example, the edge of the peripheral region 120CB of the cover plate 120C exceeds the edge of the frame 140. That is, a portion of the cover plate 120C at the peripheral region 120CB is adhered to the bearing part 141 of the frame 140 by the adhesive layer 130, and the other portion of the cover plate 120C at the peripheral region 120CB extends outwardly from the edge of the frame 140. At this point, the bottom surface 120CS2 of the cover plate 120C at the peripheral region 120CB includes a flat section adhered to the bearing part 141 and a curved section extending beyond the frame 140.

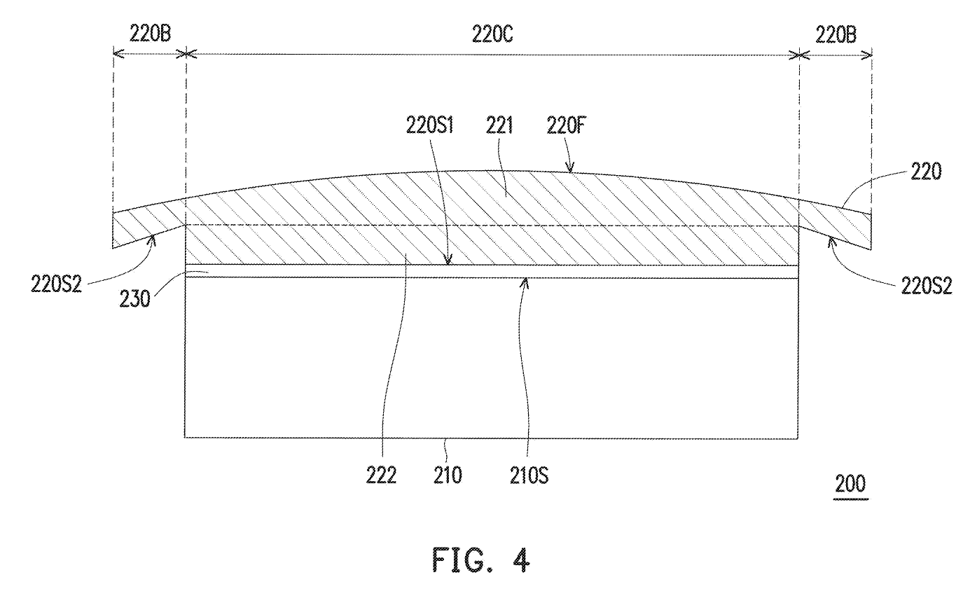

FIG. 4 is a cross-sectional schematic view illustrating a display device in yet an embodiment of the invention. Referring to FIG. 4, the display device 200 includes a display module 210 and a cover plate 220. The cover plate 220 is disposed on the display module 210 and has a central region 220C and a peripheral region 220B. The peripheral region 220B is located on at least one side of the central region 220C. From the view in FIG. 4, the peripheral region 220B is located at the periphery of the central region 220C and surrounds the central region 220C. The cover plate 220 also has a main body 221 and a protrusion 222. The main body 221 continuously extends from the central region 220C to the peripheral region 220B. The protrusion 222 is located in the central region 220C and between the main body 221 and the display module 210. In the present embodiment, the display device 200 further includes an adhesive layer 230, wherein the adhesive layer 230 is disposed between the protrusion 222 of the cover plate 220 and the display module 210 so that the protrusion 222 of the cover plate 220 is adhered to the display module 210. The protrusion 222 may completely cover the entire display module 210. The adhesive material of the adhesive layer 230 may include optical glue or other transparent materials having adhesive properties. Because of disposing the protrusion 222, a bottom surface 220S1 of the cover plate 220 at the central region 220C is located closer to a top surface 210S of the display module 210 in a height direction than a bottom surface 220S2 of the cover plate 220 at the peripheral region 220B, and the main body 221 and the protrusion 222 of the cover plate 220 are integrally formed. Otherwise, in the present embodiment, the upper surface 220F of the cover plate 220 is an arc face, but the invention is not limited thereto. By disposing the protrusion 222 between the main body 221 and the display module 210, a gap between the cover plate 220 and the display module 210 is greatly reduced. Although the adhesive layer 230 is coated on the entire surface of the display module 210, the amount of the adhesive material used to foiiii the adhesive layer 230 is greatly reduced, so as to avoid overflowing of glue, to resolve the difficulties and other problems in solidifying the optical clear adhesive, and then in order to save processing cost and achieve an optimized module.

In summary, since the cover plate of the display device has the protrusion disposed between the display module and the main body, the gap between the cover plate and the display module is reduced and even eliminated. Therefore, after the external light passes through the cover plate, the secondary refraction of the light caused by mismatched refractive indexes does not happen easily. As a result, the image quality of the display module is maintained at a better state. Otherwise, air bonding technology is adopted to the cover plate in some embodiments of the invention, so that the production cost is low and the manufacturing tools may be simpler. Therefore, the display module in the embodiments of the invention has both advantages of good display quality and simple manufacturing process.

Although the present invention and the advantages thereof have been described in detail, it should be understood that various changes, substitutions, and alternations can be made therein without departing from the spirit and scope of the invention as defined by the appended claims. That is, the discussion included in this invention is intended to serve as a basic description. It should be understood that the specific discussion may not explicitly describe all embodiments possible; many alternatives are implicit. The generic nature of the invention may not fully explained and may not explicitly show that how each feature or element can actually be representative of a broader function or of a great variety of alternative or equivalent elements. Again, these are implicitly included in this disclosure. Neither the description nor the terminology is intended to limit the scope of the claims.

What is claimed is:

1. A display device, comprising:
a display module; and
a cover plate, disposed on the display module, wherein the cover plate has a central region and a peripheral region located at one or more side of the central region, and the cover plate comprises:
a main body, continuously extending from the central region to the peripheral region; and
a protrusion, located in the central region and between the main body and the display module, such that a bottom surface of the cover plate at the central region is located closer to a top surface of the display module in a height direction than a bottom surface of the cover plate at the peripheral region.

2. The display device as recited in claim 1, further comprising:
an adhesive layer; and
a frame, surrounding the display module, wherein the frame comprises a bearing portion, and the peripheral region of the cover plate is adhered to the bearing portion of the frame by the adhesive layer.

3. The display device as recited in claim 2, wherein the protrusion is in contact with the display module.

4. The display device as recited in claim 2, wherein a thickness of the protrusion is equal to a sum of a thickness of the adhesive layer and a thickness of the bearing portion of the frame.

5. The display device as recited in claim 1, further comprising an adhesive layer, wherein the adhesive layer is disposed between the protrusion of the cover plate and the display module so that the protrusion of the cover plate is adhered to the display module.

6. The display device as recited in claim 1, wherein a top surface of the cover plate away from the display module is a non-planar surface or a planar surface.

7. The display device as recited in claim 1, wherein a part of a top surface of the cover plate at the central region is located farther from the top surface of the display module in the height direction than a part of the top surface of the cover plate at the peripheral region.

8. The display device as recited in claim 1, wherein the protrusion and the main body of the cover plate are integrally formed.

9. The display device as recited in claim 1, wherein the bottom surface of the cover plate at the peripheral region is a planar surface.

10. The display device as recited in claim 1, wherein the bottom surface of the cover plate at the peripheral region is a non-planar surface.
